(19) United States
(12) Patent Application Publication
(10) Pub. No.: US 2012/0228966 A1
(43) Pub. Date: Sep. 13, 2012

(54) ELECTRIC MOTOR AND PROCESS FOR MANUFACTURING A ROTOR OR A STATOR OF AN ELECTRIC MOTOR

(75) Inventors: Witold Pieper, Gelnhausen (DE); Burkard Kraus, Geiselbach (DE); Johannes Tenbrink, Moembris (DE)

(73) Assignee: Vacuumschmelze GmbH & Co. KG, Hanau (DE)

(21) Appl. No.: 13/228,637

(22) Filed: Sep. 9, 2011

(30) Foreign Application Priority Data
Sep. 10, 2010 (DE) 10 2010 037 466.0
Mar. 22, 2011 (DE) 10 2011 001 488.8

(51) Int. Cl. H02K 1/02; H02K 15/00; H02K 15/03; H02K 41/02

(52) U.S. Cl. 310/12.24; 310/216.004; 29/596; 29/598

(57) ABSTRACT

An electric motor with a stator and a rotor, the stator and/or the rotor comprising a soft magnetic core comprising a lamination stack, is characterised, in that the lamination stack has a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight.

### BACKGROUND

1. Field

Disclosed herein is an electric motor with a stator and a rotor. Also disclosed herein is a process for manufacturing a rotor or a stator of an electric motor.

2. Description of Related Art

Here and in the following the term “electric motor” includes any corresponding machine operated or operable as a motor or as a generator.

The hysteresis losses that occur in the soft magnetic rotor or stator cores represent a considerable component of the losses of electric motors and generators. The total losses are commonly described as the sum of three components:

Pₜₒₜₐₗ=P_{hystersis}+P_{eddy current}+P_{excess}.

The following illustrates total loss density in relation to mass and a hysteresis cycle. The first component, hysteresis losses, is strongly determined by coercive field strength. The second component, eddy current losses, dominates at high frequencies and is determined by the structure of the core and by the electrical conductivity of the material used. This is illustrated by the following equation:

$$\frac{{P}_{total}}{f} = \frac{1}{D} [ 4 {kH}_{C} {B}_{max} + \frac{{π}^{2} σ {d}^{2}}{6} {B}_{max}^{2} f + {CB}_{max}^{1.5} {f}^{0.5} ] ,$$

where f is frequency, D is density, Bₘₐₓ is maximum induction, d is lamination thickness, a is electrical conductivity and H_{c} is coercive field strength, and C is a structure-dependent value.

The formation of soft magnetic cores of a rotor or stator from lamination stacks in order to minimise the influence of eddy currents is known from DE 695 28 272 T2.

### SUMMARY

There remains a need in the art for an electric motor with lower losses.

Furthermore, there remains a need for a process for manufacturing a rotor or a stator of an electric motor.

These needs are met by means of embodiments and aspects of the subject matter disclosed herein. Further advantageous aspects of these embodiments are also disclosed.

According to one embodiment, an electric motor is provided with a stator and a rotor, this stator and/or this rotor comprising a soft magnetic core in the form of a lamination stack. The material used for the lamination stack has a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight.

The impurities may, for example, be O, N, C, S, Mg or Ca or mixtures of two or more of these elements, these impurities being in particular below the following limits: Ca≦0.0025% by weight, Mg≦0.0025% by weight, S≦0.01% by weight, O≦0.01% by weight, N≦0.005% by weight and C≦0.02% by weight.

In certain embodiments, the level of impurities can be kept low by, for example, cerium reduction or Vacuum Induction Melting (VIM), Vacuum Arc Remelting (VAR), Electro Slag Remelting (ESR) and/or by other processes.

In certain embodiments disclosed herein, an increasing chromium content or an increasing molybdenum content can lead to further reduction in coercive field strength. However, the effect is dependent on the nickel content. If the nickel content is too high or too low, no significant reduction in coercive field strength is achieved. Consequently, in addition to iron, the alloy disclosed in the invention has a nickel content within a range of 35 to 50% by weight and a chromium and/or molybdenum content of 0.5 to 8% by weight.

In certain embodiments, the sum of the two elements Mo and Cr is kept below 8% by weight to prevent the saturation induction range from falling too far.

The material used has a combination of high electrical resistance and low coercive field strength, which leads to very low total losses. It is therefore particularly suitable for constructing low-loss lamination stacks at conventional lamination thicknesses and for insulating the individual lamination layers from one another. A saturation induction range of significantly over 1 T allows the system to operate at the desired level and the high Curie temperature of the material limits the fall in the saturation induction range when used at temperatures over 100° C.

An example of this type of material is that available commercially under the name ULTRAVAC 44 V6 which has a composition of 44% by weight nickel, 3.5% by weight molybdenum, residual iron and impurities. This material has a saturation induction range of 1.38 T, an electrical resistivity of 0.8 μΩm, a coercive field strength of 30 mA/cm and a Curie temperature of approximately 300° C.

According to one of the principles underlying the disclosed herein, such materials are therefore suitable not only for manufacturing solid, one-piece components, but also for constructing lamination stacks. They can thus first be formed into an isotropic material suitable for isotropic lamination stacks of rotating machines or linear drives.

In one embodiment the lamination stack comprises a plurality of individual laminations stacked one on top of another and oriented in a plane perpendicular to the axis of rotation of the rotor.

The resulting lamination stack is rotationally symmetrical and composed of laminations of constant thickness d. It is therefore relatively simple to manufacture.

The lamination stack can essentially be designed as a cylinder or hollow cylinder and in particular as a stator magnetic return part.

According to one aspect disclosed herein, the electric motor is a linear motor comprising a stator and a carriage, the stator and/or the carriage comprising a soft magnetic core comprising a lamination stack. The carriage is the movable part of the linear motor. The lamination stack has a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight.

In one embodiment the nickel content is 38% by weight≦Ni≦45% by weight, in particular 42% by weight≦Ni≦45% by weight.

The sum of the chromium and molybdenum contents in one embodiment is 1% by weight≦(Cr+Mo)≦8% by weight.

In one embodiment the chromium content is equal to 0 and 3% by weight≦Mo≦4% by weight.

In one embodiment the alloy also comprises Co, the cobalt content being 0% by weight<Co≦0.5% by weight. Co can increase the saturation induction range.

The alloy used advantageously has an electrical resistivity ρ of ρ>0.5 μΩm, in particular of ρ>0.75 μΩm.

It advantageously has a coercive field strength H_{c} of H_{c}<35 mA/cm or even H_{c}<30 mA/cm. This can be achieved in particular by appropriate heat treatment of the lamination stack.

The alloy used advantageously has a saturation induction Bₛ of Bₛ>1 T.

The advantage of the use of the alloy described is that due to its material properties it allows lower material losses to be set than previously used materials, thereby permitting the production of particularly low-loss lamination stacks.

According to one aspect disclosed herein, a process is provided for manufacturing a rotor or a stator of an electric motors or a stator or a carriage of an electric motor designed as a linear motor comprising the following steps:
provision of a plurality of individual laminations made of an alloy with a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight;
stacking of the plurality of individual laminations to form a lamination stack;
structuring of the lamination stack to form a core of a rotor or stator.

According to a further aspect disclosed herein, a process is provided for manufacturing a rotor or stator of an electric motor or a stator or a carriage of an electric motor designed as a linear comprising the following steps:
provision of a plurality of individual laminations made of an alloy with a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight;
structuring of the individual laminations;
stacking of the plurality of structured individual laminations to form a lamination stack, thereby forming a core for a rotor or stator.

Both variants of the process permit the rational manufacture of low-loss lamination stack for rotors, carriages and stators of an electric motor.

### BRIEF DESCRIPTION OF DRAWINGS

Embodiments are described in greater detail below with reference to the drawings.

FIG. 1 illustrates a schematic representation of a top view of a stator and a rotor of an electric motor as disclosed in one embodiment.

FIG. 2 illustrates a schematic representation of a section through the stator of the electric motors illustrated in FIG. 1.

FIG. 3 illustrates a diagram of total loss density in relation to mass and a hysteresis cycle for a material of an embodiment disclosed herein and for a reference material.

FIG. 4 illustrates a further diagram of total loss density in relation to mass and a hysteresis cycle for a material of an embodiment disclosed herein and for two reference materials.

FIG. 5 illustrates a further diagram of total loss density in relation to mass and a hysteresis cycle for a material of an embodiment disclosed herein and for a reference material.

### DETAILED DESCRIPTION OF SPECIFIC EMBODIMENTS

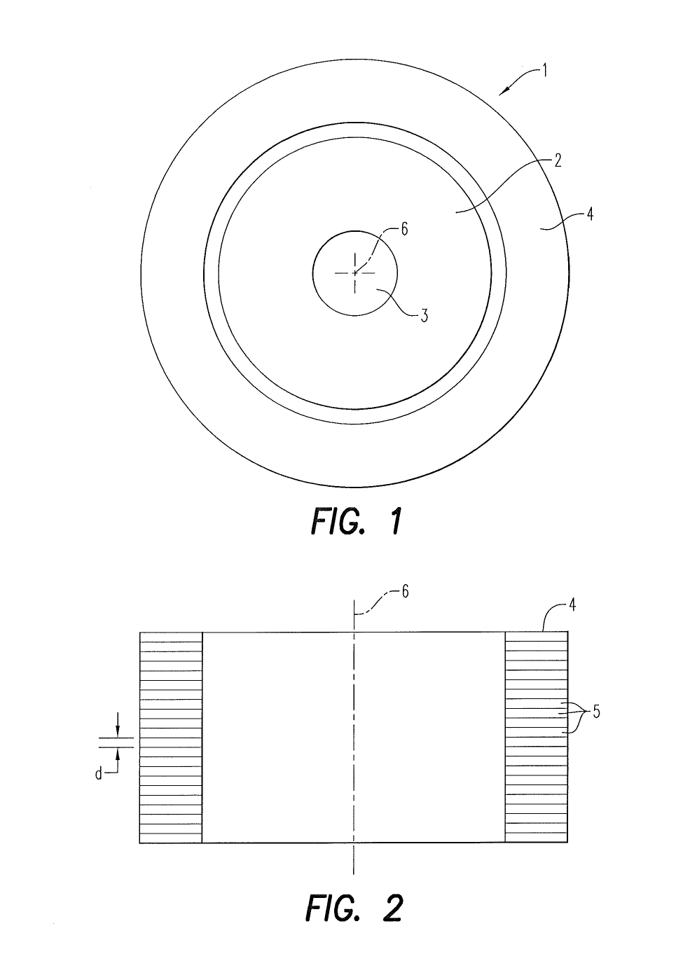

FIG. 1 illustrates a schematic representation of a top view of an electric motor 1 with a stator 4 and a rotor 2. For the sake of clarity, further components of the electric motors 1 such as, for example, coils and electrical connections are not illustrated.

The stator 4 is essentially designed as a hollow cylinder having axis of rotation 6. It is designed as a lamination stack comprising a plurality of individual laminations 5 of thickness d which are oriented perpendicular to the axis of rotation 6 of the rotor 2 and stacked one on top of another as illustrated schematically in FIG. 2.

The rotor 2 is supported inside the stator 4 in such a manner that it is able to rotate. The rotor 2 can also be designed as a lamination stack comprising a plurality of individual laminations which are stacked one on top of another, for example in the manner described. The rotor 2 is essentially cylindrical in shape and has inside it an opening 3 to receive a rotor shaft which is not illustrated. Desirably, rotor 2 also has axis of rotation 6, and is therefore concentric with stator 4. More particularly, desirably rotor 2 and/or stator 4 are rotationally symmetric with respect to axis 6.

FIG. 2 illustrates a schematic representation of a cross section of the stator 4 illustrated in FIG. 1 in which the layers of individual laminations 5 are indicated by the thickness d.

The individual laminations 5 consist of an alloy with a composition described by the following formula:

35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight.

This alloy is an iron/nickel-based alloy with chromium and/or molybdenum. The elements chromium and molybdenum can reduce coercive field strength considerably compared to a pure Ni—Fe alloy while saturation is above 1 T and thus higher than is the case with 80% Ni—Fe permalloy alloys, for example.

Table 1 below illustrates examples of suitable alloy compositions with low coercive field strengths and high resistivity for low-loss lamination stacks:

TABLE 1

| | | Ni | Cr | Mo | | | |
|---|---|---|---|---|---|---|---|
| | | % by | % by | % by | Hc | | Resistivity |
| | Fe | wt | wt | wt | (mA/cm) | Bₘₐₓ(T) | μΩm |
| 8368 | Residual | 40 | 4.5 | | 34.8 | 1.09 | 0.91 |
| 8371 | Residual | 42.95 | 5.8 | | 28.1 | 1.02 | 0.94 |
| 8372 | Residual | 44 | 4.5 | | 29 | 1.15 | 0.88 |
| 8373 | Residual | 44 | 5.8 | | 31.2 | 1.05 | 0.94 |
| 8376 | Residual | 40 | | 1.9 | 33.6 | 1.3 | 0.79 |
| 8377 | Residual | 40 | | 4.3 | 29.5 | 1.15 | 0.89 |
| 8378 | Residual | 41.7 | | 5.5 | 30.9 | 1.12 | 0.92 |
| 8379 | Residual | 40 | 2.2 | 2.1 | 29.4 | 1.12 | 0.90 |

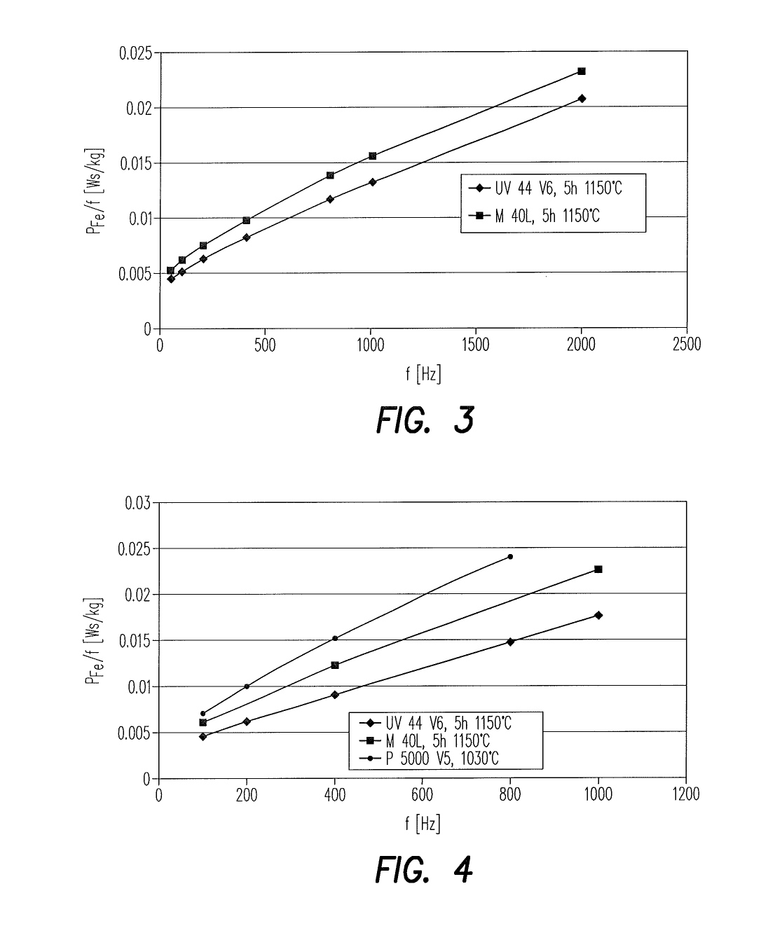

FIG. 3 illustrates a diagram of total loss density in relation to mass and a hysteresis cycle P_{Fe}/f for a material disclosed in an embodiment of the invention and a reference material.

In this case the ULTRAVAC 44 V6 discussed above was used as an example of a material disclosed in the invention. It has a composition of 44% by weight nickel, 3.5% by weight molybdenum, residual iron and impurities. The reference material used was MEGAPERM 40 L which has a composition of 40% nickel and residual iron. Lamination stacks with an individual lamination thickness of 0.1 mm were made from both materials. The induction was 1.2 T.

FIG. 4 illustrates a further diagram of total loss density in relation to mass and a hysteresis cycle P_{Fe}/f for a material disclosed in an embodiment of the invention and two reference materials.

In this case ULTRAVAC 44 V6 was again used as an example of a material disclosed in the invention. In addition to MEGAPERM 40 L, Permenorm 5000 V5, which has a composition of 48% nickel and residual iron, was also used as a reference material. Lamination stacks with an individual lamination thickness of 0.2 mm were made from all the materials. The induction was 1 T.

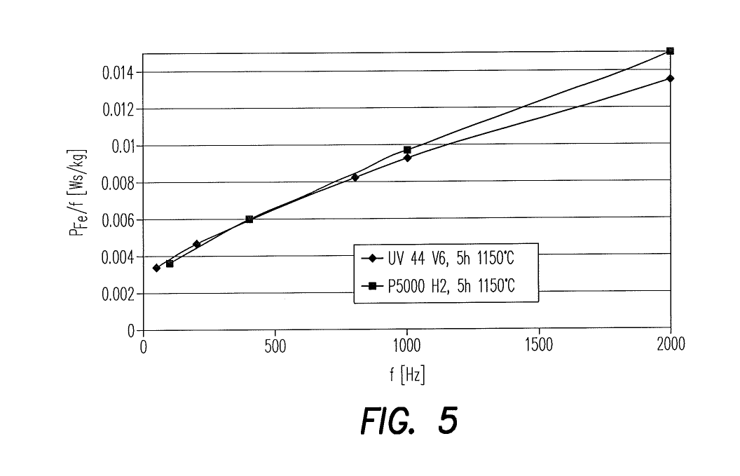

FIG. 5 illustrates a further diagram of total loss density in relation to mass and a hysteresis cycle P_{Fe}/f for a material disclosed in an embodiment of the invention and a reference material.

In this case U1TRAVAC 44 V6 was again used as an example of a material disclosed in the invention. The reference material used was Permenorm 5000 H2. Lamination stacks with an individual lamination thickness of 0.1 mm were made from both materials. The induction was 1 T.

FIGS. 3 to 5 indicate that the lamination stacks made of ULTRAVAC 44 V6 have particularly low material losses. At levels lower than those shown in FIGS. 3 to 5 of below 1 T the loss advantage increases still further.

The invention having been described herein with respect to certain of its specific embodiments and examples, it will be understood that these do not limit the scope of the appended claims.

1. An electric motor comprising a stator and a rotor, or a stator and a carriage, wherein any or all of the stator, the rotor and the carriage comprise a soft magnetic core comprising a lamination stack comprising one or more individual laminations having a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight.

2. The electric motor in accordance with claim 1, wherein the lamination stack comprises a plurality of individual laminations stacked one on top of another and oriented in a plane perpendicular to the axis of rotation of the rotor.

3. The electric motor in accordance with claim 1, wherein the lamination stack is in the form of a cylinder or a hollow cylinder.

4. The electric motor in accordance with claim 1, wherein the electric motor is a linear motor comprising a stator and a carriage, the stator or the carriage or both have a magnetic core comprising the lamination stack.

5. The electric motor in accordance with claim 1, wherein the nickel content is 38% by weight≦Ni≦45% by weight.

6. The electric motor in accordance with claim 5, wherein the nickel content is 42% by weight≦Ni≦45% by weight.

7. The electric motor in accordance with claim 1, wherein the sum of the chromium and molybdenum contents is 1% by weight≦15 (Cr+Mo)≦8% by weight.

8. The electric motor in accordance with claim 1, wherein the chrome content is equal to 0 and 3% by weight≦Mo≦4% by weight.

9. The electric motor in accordance with claim 1, wherein the cobalt content is 0% by weight≦Co≦0.5% by weight.

10. The electric motor in accordance with claim 1, wherein the electrical resistivity ρ is such that ρ>0 μΩm.

11. The electric motor in accordance with claim 10, wherein the electrical resistivity ρ is such that ρ>0.75 μΩm.

12. The electric motor in accordance with claim 1, wherein the coercive field strength H_{c} is such that H_{c}<35 mA/cm.

13. The electric motor in accordance with claim 1, wherein the coercive field strength H_{c} is such that H_{c}<30 mA/cm.

14. The electric motor in accordance with claim 1, wherein the saturation induction B_{S} is such that B_{S}>1 T.

15. A process for manufacturing a rotor, or stator, or carriage of an electric motor comprising:
providing of a plurality of individual laminations comprising an alloy with a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight;
stacking of the plurality of individual laminations to form a lamination stack; and
structuring of the lamination stack to form a core of a rotor or stator or carriage.

16. A process for manufacturing a rotor, or stator, or carriage of an electric motor comprising:
providing of a plurality of individual laminations made of an alloy with a composition of 35% by weight≦Ni≦50% by weight, 0% by weight≦Co≦2% by weight, 0% by weight≦Mn≦1.0% by weight, 0% by weight≦Si≦0.5% by weight and 0.5% by weight≦Cr≦8% by weight and/or 0.5% by weight≦Mo≦8% by weight, residual iron and unavoidable impurities, where 0.5% by weight≦(Mo+Cr)≦8% by weight;
structuring of the individual laminations; and
stacking of the plurality of structured individual laminations to form a lamination stack, thereby forming a core for a rotor or stator or carriage.
